(19) United States
(12) Patent Application Publication
(10) Pub. No.: US 2009/0190575 A1
(43) Pub. Date: Jul. 30, 2009

(54) PACKET CAPTURING APPARATUS, PACKET CAPTURING METHOD AND PACKET CAPTURING PROGRAM

(75) Inventors: Noriyuki FUKUYAMA, Kawasaki (JP); Masanobu Morinaga, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/332,060

(22) Filed: Dec. 10, 2008

(30) Foreign Application Priority Data
Dec. 11, 2007 (JP) 2007-320026

(51) Int. Cl. H04L 12/66

(52) U.S. Cl. 370/352

(57) ABSTRACT

A packet capturing apparatus and method are provided. The packet capturing apparatus includes an acquisition part acquiring a voice packet having voice information, after receiving each packet transferred in a network, from received packets. The packet capturing apparatus also includes a measuring part measuring an elapsed time after receiving the acquired voice packet and an acquisition part starting to receive a voice packet transferred in a direction opposite to a transfer direction of the acquired voice packet when the elapsed time reaches a predetermined standby time.

### CROSS-REFERENCE TO RELATED APPLICATION(S)

This application is related to and claims priority to Japanese application having serial number 2007-320026, filed Dec. 11, 2007 in the Japan Patent Office, the entire contents of which are incorporated by reference herein.

### BACKGROUND

1. Field

The embodiments discussed herein are directed to a packet capturing apparatus, a packet capturing method, and a packet capturing program.

2. Description of the Related Art

Conventionally, a voice packet capturing apparatus acquires each packet flowing in both directions in a network to acquire a voice packets constituted by containing voice information from each of the received packets.

To describe an example, in a network configuration as shown in FIG. 1 in which a plurality of IP telephones is connected to a network, a conventional voice packet capturing apparatus receives all packets flowing in the network via TAP installed in the network to determine whether each of all the received packets is constituted by containing voice information.

Then, the conventional voice packet capturing apparatus acquires voice packets by storing each voice packet determined to be constituted by containing voice information in a storage part.

### SUMMARY

It is an aspect of the embodiments discussed herein to provide a voice packet capturing apparatus including a first acquisition part acquiring a voice packet having voice information, after receiving each packet transferred in a network, from the received packets; a measuring part measuring an elapsed time after receiving the acquired voice packet; a second acquisition part starting to receive a voice packet transferred in a direction opposite to the transfer direction of the acquired voice packet when the elapsed time reaches a predetermined standby time; and an output part outputting the voice packet acquired by the first acquisition part and the voice packet acquired by the second acquisition part corresponding to the acquired voice packet to an echo detection device detecting an echo generated when the voice information is decoded based on each of the voice packets.

These together with other aspects and advantages which will be subsequently apparent, reside in the details of construction and operation as more fully hereinafter described and claimed, reference being had to the accompanying drawings forming a part hereof wherein like numerals refer to like parts throughout.

### BRIEF DESCRIPTION OF THE DRAWINGS

FIG. 1 illustrates a conventional network;

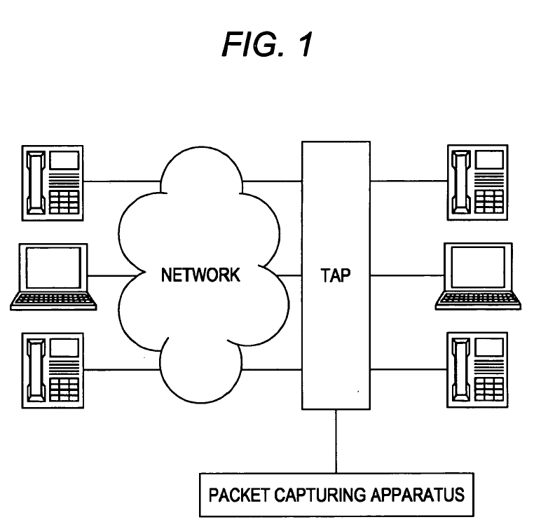

FIG. 2 illustrates a measuring device according to a first embodiment;

FIG. 3 illustrates an exemplary embodiment of the measuring device;

FIG. 4 illustrates processing by the measuring device;

FIG. 5 illustrates an exemplary embodiment of a measuring device according to a second embodiment;

FIG. 6 illustrates processing by the measuring device according to the second embodiment;

FIG. 7 illustrates a measuring device according to a third embodiment;

FIG. 8 illustrates information stored in a delay time storage part;

FIG. 9 illustrates a flow of processing by the measuring device according to the third embodiment;

FIG. 10 illustrates a flow of standby processing by a measuring device according to a fourth embodiment;

FIG. 11 illustrates a configuration of a measuring device according to a fifth embodiment;

FIG. 12 illustrates a flow of processing by the measuring device according to the fifth embodiment;

FIG. 13 illustrates a flow of packet A receiving processing by the measuring device according to the fifth embodiment; and

FIG. 14 illustrates a computer executing packet capturing programs.

### DETAILED DESCRIPTION OF THE EMBODIMENTS

Conventional voice packet capturing apparatus is not configurable by an inexpensive function part.

That is, conventionally, a voice packet capturing apparatus receives all packets flowing in both directions in a network to determine whether each of all the received packets is constituted by containing voice information.

Thus, the quantity of packets for determination processing becomes enormous in proportion to the quantity of packets flowing in the network so that a function part capable of completing operations of determination processing within an effective time is needed.

A processing part with such processing capabilities is expensive and consumes a lot of power.

Moreover, conventionally, the caputure apparatus stores all voice packets determined to be constituted by containing voice information so that a storage part having a large storage capacity capable of storing a large quantity of voice packets is needed.

Such a storage part having a large storage capacity is expensive and consumes plenty of power.

Exemplary embodiments of a packet capturing apparatus, packet capturing method, and packet capturing programs are described below in detail with reference to the drawings.

An exemplary embodiment of the present invention is a measuring device.

A measuring device, for example, monitors quality of voice information contained in voice packets by detecting voice packets containing an echo.

In the first embodiment shown below, an overview and features of a measuring device according to the first embodiment, a configuration of the measuring device, and a flow of processing of the measuring device are described in turn and lastly, an effect of the first embodiment is described.

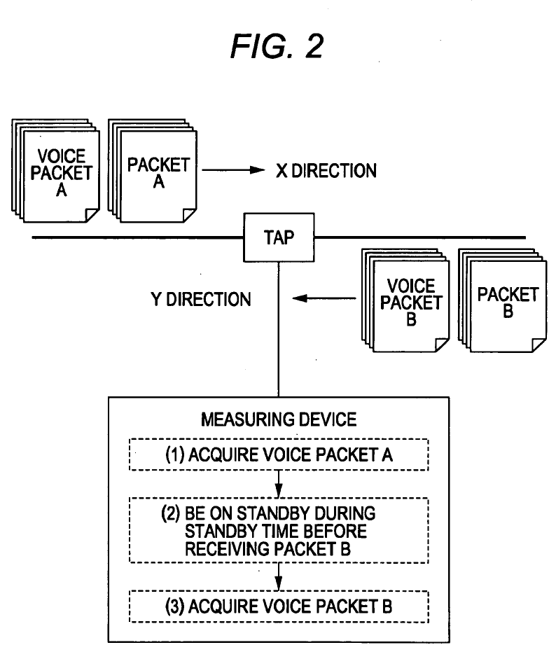

An overview and features of a measuring device according to the first embodiment will be provided using FIG. 2.

FIG. 2 illustrates an overview and features of a measuring device according to the first embodiment.

The measuring device according to the first embodiment receives each packet flowing in both directions in a network to acquire voice packets having voice information from each of the received packets.

The measuring device according to the first embodiment can reduce the number of packets to be received and that of voice packets to be stored and, as a result, the measuring device can be configured by an inexpensive part while maintaining quality of measurement so that power consumption can be reduced.

More specifically, the measuring device according to the first embodiment has a standby time after acquiring voice packets flowing in a predetermined direction in a network before starting to receive packets flowing in a direction opposite to the predetermined direction in the network.

Then, after acquiring voice packets flowing in the predetermined direction in the network, the measuring device according to the first embodiment starts to receive each packet flowing in a direction opposite to the predetermined direction in the network after the standby time passes.

More specifically, the measuring device according to the first embodiment receives all packets (hereinafter, referred to as a packet A) flowing in a predetermined direction (for example, in the X direction) via TAP set up in a network.

The measuring device determines whether or not the received packet A has voice information and stores the packet A determined to have voice information (hereinafter, referred to as a voice packet A) in the storage part to acquire the voice packet A ((1) in FIG. 2).

Here, if the voice packet A is acquired, the measuring device according to the first embodiment is on standby until a standby time passes before receiving all packets (hereinafter, referred to as a packet B) flowing in a direction (for example, the Y direction) opposite to the direction in which the acquired packets flow ((2) in FIG. 2).

After the standby time passes, the measuring device according to the first embodiment starts to receive the packet B via TAP set up in the network.

The measuring device determines whether or not the received packet B has voice information and stores the packet B determined to have voice information (hereinafter, referred to as a voice packet B) in the storage part to acquire the voice packet B ((3) in FIG. 2).

The measuring device according to the first embodiment can reduce the number of packets to be received and that of voice packets to be stored by the above method and thus, can be configured by an inexpensive function part.

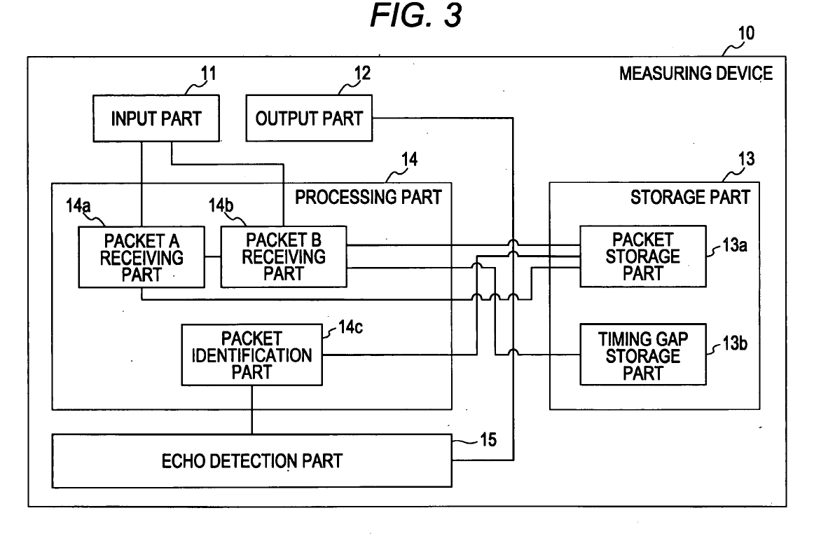

Next, a configuration of the measuring device shown in FIG. 2 will be described using FIG. 3.

FIG. 3 illustrates a configuration of the measuring device.

As shown in FIG. 3, a measuring device 10 includes an input part 11, an output part 12, a storage part 13, a processing part 14, and an echo detection part 15.

The input part 11 receives various kinds of information.

More specifically, the input part 11 includes, for example, keyboard, a mouse, a microphone, and a single or a plurality of input ports and, for example, receives the packet A and the packet B via TAP set up in a network.

The output part 12 outputs various kinds of information.

More specifically, the output part 12 includes a monitor, display, touch panel, a single or a plurality of input ports or the like and, for example, outputs and displays a detection result or transmits a detection result to a quality monitoring device.

The storage part 13 stores data and programs needed for various kinds of processing by the processing part 14.

The storage part 13 includes, among storage parts closely related to the present invention, a packet storage part 13a and a timing gap (standby time) storage part 13b.

The packet storage part 13a stores acquired voice packets.

More specifically, the packet storage part 13a stores each of the voice packet A acquired by a packet A receiving part 14a described later and the voice packet B acquired by a packet B receiving part 14b described later.

The timing gap storage part 13b stores a standby time after acquiring voice packets flowing in a predetermined direction in a network and before starting to receive packets flowing in a direction opposite to the direction in which the acquired packets flow in the network.

More specifically, the timing gap storage part 13b stores a standby time (hereinafter, referred to as a timing gap) after acquiring the voice packet A by the packet A receiving part 14a described later and before starting to acquire the voice packet B by the packet B receiving part 14b described later.

Here, the length of time of the “timing gap” is, for example, the reproduction time (20 milliseconds, referred to as a frame time below, or 100 milliseconds, typical round trip time in the network) of voice information contained in a voice packet.

The processing part 14 has an internal memory to store control programs such as an operating system, programs specifying various processing procedures, and needed data and performs various kinds of processing by using these programs and data.

The processing part 14 includes, among processing parts closely related to the present invention, the packet A receiving part 14a, the packet B receiving part 14b, and a packet identification part 14c.

The packet B receiving part 14b corresponds to a “second acquisition part” in claims.

The packet A receiving part 14a receives the voice packet A.

More specifically, the packet A receiving part 14a starts to receive the packet A at any time (for example, when a measurement request is received from a user or at intervals of 1 sec) and determines whether or not each of all the received packets A is the voice packet A containing voice information.

Here, the packet A receiving part 14a acquires the voice packet A by storing each packet A determined to contain voice information as the voice packet A in the packet storage part 13a and notifies the packet B receiving part 14b of acquisition of the voice packet A.

Processing to acquire the voice packet A (B) represents processing including processing to receive the packet A (B), processing to determine whether or not each packet A (B) is the voice packet A containing voice information, and processing to store the voice packet A (B) in the packet storage part 13a.

Then, after a fixed time (for example, 1 sec) passes or when the number of the voice packets A stored in the packet storage part 13a reaches a predetermined number, the packet A receiving part 14a ends acquisition of the voice packets A by terminating reception of the packets A.

Here, the number of packets as a “predetermined number” is the number of voice packets needed for voice quality calculations, for example, when an echo is tried to be detected, the number of voice packets must contain the enough number of voice packets (it means enough time of voice) for an echo calculation.

If, for example, a voice for one second is needed as an original voice to detect an echo and voice packets are acquired from Ethernet (registered trademark) of 100 Mbps (Mega bits per second) in which only voice packets of IP telephone (if G. 711 codec is used at a frame time of 20 ms) are transmitted at a wire speed, the number of packets as the “predetermined number” is about 60,000.

When the packet A receiving part 14a acquires the voice packet A, the packet B receiving part 14b starts to receive each packet B after the timing gap passes.

More specifically, after receiving a notification of acquisition of the voice packet A from the packet A receiving part 14a, the packet B receiving part 14b reads the timing gap from the timing gap storage part 13b and is on standby during timing gap before receiving the packet B.

Subsequently, after the timing gap passes, the packet B receiving part 14b starts to receive the packet B and determines whether or not each of the all received packets B is the voice packet B constituted by containing voice information.

Here, the packet B receiving part 14b acquires the voice packet B by storing the packet B determined to contain voice information as the voice packet B in the packet storage part 13a.

Then, after a fixed time (for example, 1 sec) passes or when the number of the voice packets B stored in the packet storage part 13a reaches a predetermined number, the packet B receiving part 14b ends acquisition of the voice packets B by terminating reception of the packets B.

Here, the number of packets as a “predetermined number” is the number of voice packets needed, for example, to determine whether an echo to an original voice is contained when an echo is tried to be detected, as a voice that may contain an echo.

The packet identification part 14c identifies each voice packet exchanged between predetermined terminals.

More specifically, the packet identification part 14c reads the voice packet A from the packet storage part 13a to extract session information contained in the voice packet A.

Then, the packet identification part 14c reads the voice packet B from the packet storage part 13a to identify the packet B containing the same session information as that contained in the voice packet A.

Here, session information is information to distinguish terminals between which voice packets are exchanged.

For example, the packet identification part 14c identifies each voice packet exchanged between the predetermined terminals by identifying the voice packet B containing the same transmission/reception IP address pair (and the same transmission/reception port number pair) as the transmission/reception IP address pair (and the same transmission/reception port number pair) contained in the predetermined voice packet A.

Then, the packet identification part 14c outputs the voice packets A and the voice packets B containing the same session information to the echo detection part 15.

The echo detection part 15 detects an echo generated when voice information is decoded.

More specifically, the echo detection part 15 detects the voice packet B containing an echo generated when voice information of the voice packet A is decoded by determining whether or not an echo with respect to the voice packet A is contained in the voice packet B based on voice information contained in each voice packet A and each voice packet B received from the packet identification part 14c.

Then, if the echo detection part 15 detects the voice packet B containing an echo, the echo detection part 15 outputs and displays a detection result via the output part 12 or transmits a detection result to a quality monitoring device.

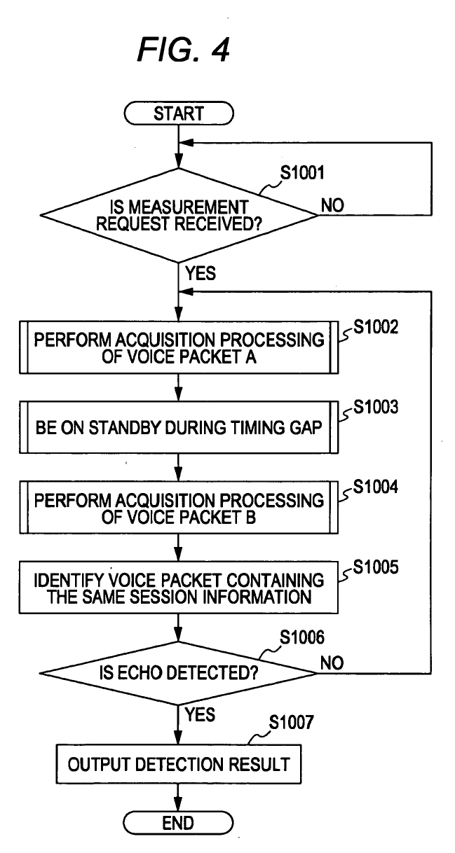

Next, processing by the measuring device 10 will be described using FIG. 4.

FIG. 4 illustrates a flow of processing by the measuring device.

As shown in FIG. 4, when a measurement request from a user is received (operation S1001, Yes), the measuring device 10 acquires the voice packet A (operation S1002).

After acquiring the voice packet A, the measuring device 10 is on standby during timing gap before receiving the packet B (operation S1003).

After the timing gap passes, the measuring device 10 acquires the voice packet B (operation S1004) and identifies the voice packet B containing the same session information as that contained in the voice packet A (operation S1005).

Subsequently, the measuring device 10 performs detection processing of an echo generated when voice information is decoded (operation S1006) and if an echo is detected (operation S1006, Yes), outputs a detection result (operation S1007) before terminating processing.

If, on the other hand, no echo is detected (operation S1006, No), the measuring device 10 repeatedly performs the above processing (operation S1002 to operation S1007) by acquiring the voice packet A again (operation S1002).

According to the first embodiment, voice packets flowing in a predetermined direction are acquired and further, a measuring device is on standby until a timing gap passes before receiving packets flowing in an opposite direction and therefore, the number of packets to be received and that of voice packets to be stored can be reduced compared with a case in which all packets flowing in a network are received.

Incidentally, if no echo should be detected by the measuring device 10 according to the first embodiment, the length of the timing gap may be changed.

Thus, in the second embodiment, a case in which the length of the timing gap is changed will be described.

In the second embodiment, a configuration of the measuring device 10 according to the second embodiment and a flow of processing by the measuring device 10 will be described. An effect obtained by the second embodiment will be described thereafter.

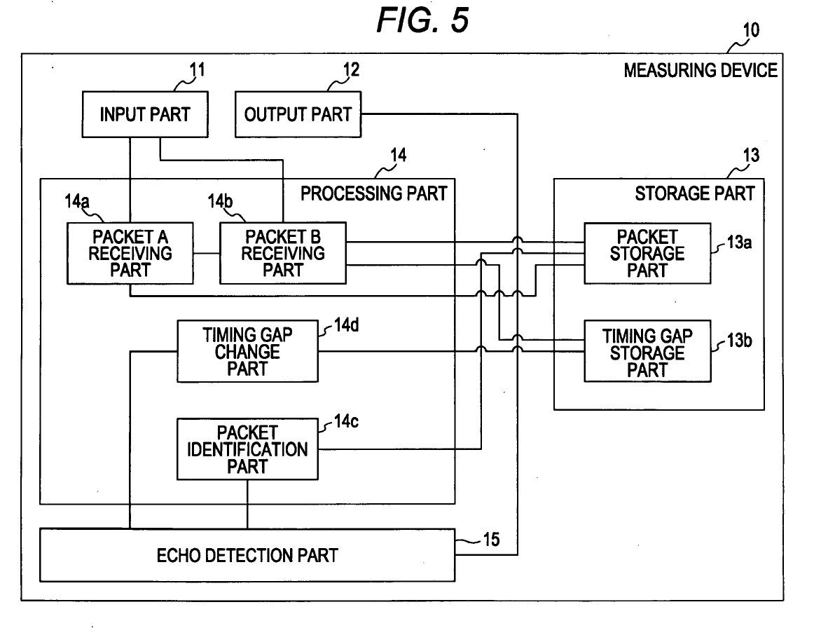

A configuration of the measuring device 10 according to the second embodiment will be described using FIG. 5.

FIG. 5 illustrates a configuration of a measuring device according to the second embodiment.

In addition to being newly provided with a timing gap change part 14d, a configuration of the measuring device 10 according to the second embodiment is different from the measuring device 10 according to the first embodiment in a respect described below.

That is, if no echo is detected, the echo detection part 15 notifies the timing gap change part 14d that no echo is detected.

If no echo is detected by the echo detection part 15, the timing gap change part 14d updates the standby time stored in the timing gap storage part 13b by adding or subtracting the reproduction time of voice information.

According to an embodiment a timing gap change part 14d corresponds to a “standby time updater”.

More specifically, if a notification that no voice packet B containing an echo is detected is received from the echo detection part 15, the timing gap change part 14d updates the timing gap stored in the timing gap storage part 13b by adding or subtracting the frame time (20 milliseconds).

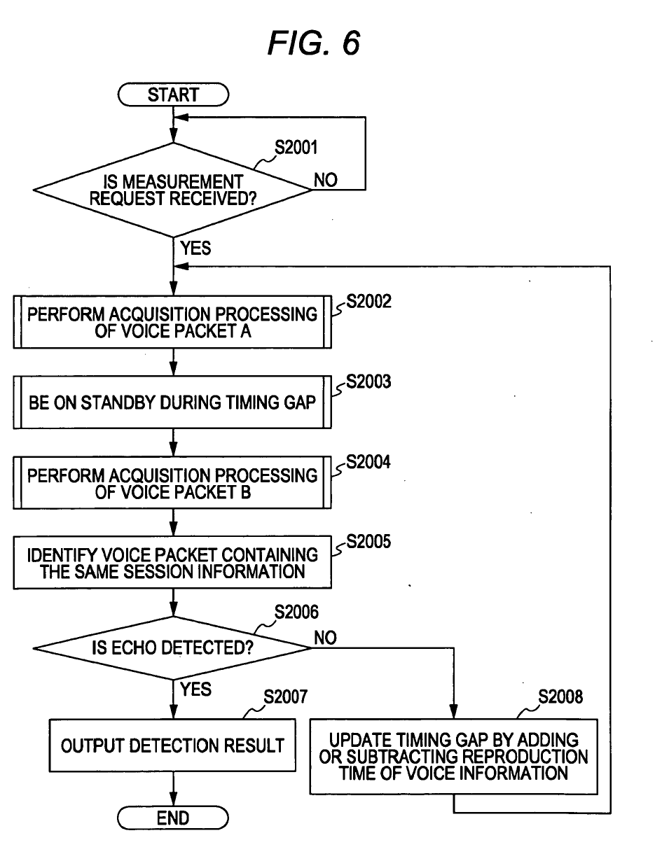

Next, processing by the measuring device 10 according to the second embodiment will be described using FIG. 6.

FIG. 6 illustrates a flow of processing by the measuring device according to the second embodiment.

Processing different from that by a measuring device according to the first embodiment will be described in detail below.

When the timing gap stored in the timing gap storage part 13b reaches, for example, 400 milliseconds (that is, a limit value of delay time of voice packets in which voice information corresponding to class C of the IP telephone is continuously decoded) after addition or reaches the same value as the timing gap after subtraction, the measuring device 10 terminates processing.

As shown in FIG. 6, like the measuring device 10 according to the first embodiment, the measuring device 10 according to the second embodiment performs detection processing of voice packets containing an echo (operation S2001 to operation S2006 (corresponding to operation S1001 to operation S1006 shown in FIG. 4)).

Here, if an echo is detected (operation S2006: Yes), the measuring device 10 according to the second embodiment outputs a detection result (operation S2007) before terminating processing.

If, on the other hand, no echo is detected (operation S2006; No), the measuring device 10 repeatedly performs the above processing (operation S2002 to operation S2008) by updating the stored timing gap by adding or subtracting the reproduction time of voice information (operation S2008) and then acquiring the voice packet A again (operation S2002).

According to the second embodiment, as described above, the number of packets to be received and that of voice packets to be stored can further be reduced by changing the standby time based on a detection result of voice packets containing an echo.

Incidentally, a case in which the frame time is used as a timing gap is described in the first and second embodiments, but the timing gap may be calculated by using control information (for example, an RTCP packet: RTP (real-time transport protocol) control protocol) used for transmission/reception of packets and stored.

The above calculation processing may be calculated in advance before acquiring voice packets or in parallel with acquisition processing of voice packets.

Thus, in the third embodiment, a case in which the timing gap is calculated and stored will be described.

In the third embodiment, a configuration of the measuring device 10 according to the third embodiment and a flow of processing by the measuring device 10 will be described. An effect obtained by the third embodiment will be described thereafter.

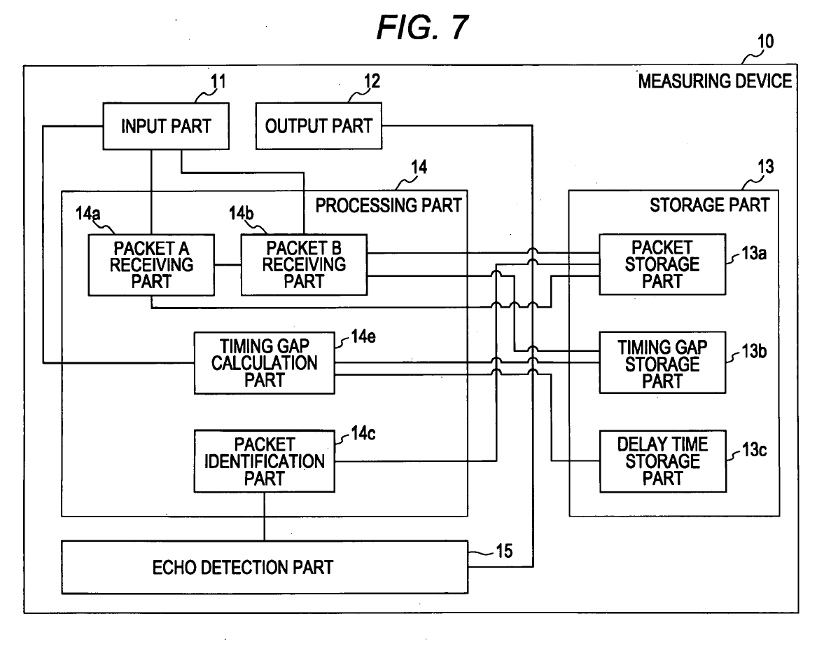

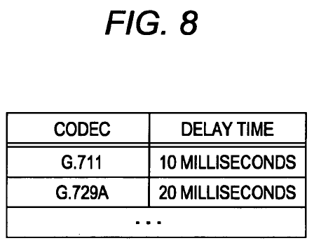

First, a configuration of the measuring device 10 according to the third embodiment will be described using FIG. 7 and FIG. 8.

FIG. 7 illustrates a configuration of a measuring device according to a third embodiment.

FIG. 8 illustrates information stored in a delay time storage part.

In addition to being newly provided with a delay time storage part 13c and a timing gap calculation part 14e, a configuration of the measuring device 10 according to the third embodiment is different from that of the measuring device 10 according to the first embodiment in a respect described below.

That is, the timing gap storage part 13b stores a calculation result by the timing gap calculation part 14e as a timing gap.

The delay time storage part 13c stores a delay time specific to the function part constituting an IP telephone.

More specifically, the delay time storage part 13c stores the name of codec (for example, G. 711 and G. 729A) and the specific delay time (for example, 10 milliseconds and 20 milliseconds) when the codec is used by associating the codec and delay time for each codec constituting the IP telephone.

Here, the delay time is a time needed to decode voice information contained in a voice packet by, for example, the codec G. 711.

The timing gap calculation part 14e calculates the timing gap in advance by using control information used for transmission/reception control of packets.

According to an embodiment, a-timing gap calculation part 14e corresponds to a “standby time calculator”.

More specifically, the timing gap calculation part 14e calculates the delay time in a network.

For example, the timing gap calculation part 14e acquires RR (receiver report) packets and SR (sender report) packets of RTCP packets via the input part 11.

Then, the timing gap calculation part 14e calculates a time difference between a time when SR packets of RTCP packets notified in the direction of the voice packet A are acquired and a time when RR packets (or SR packets) of RTCP packets notified in the direction of the voice packet B are acquired and further subtracts a time (DLSR: delay since last SR) needed to transmit RR packets (or SR packets) of RTCP packets by the IP telephone contained in RR packets (or SR packets) of RTCP packets notified in the direction of the voice packet B from the time difference to calculate the delay time in a network.

The timing gap calculation part 14e also forecasts and calculates the setting time set as a fluctuation absorption buffer length in the IP telephone by using the acquisition time of each voice packet A.

Here, the fluctuation absorption buffer length is a holding time set to each IP telephone to continuously perform decoding of voice information between a time when the first voice packet is acquired and a time when decoded voice information is output.

For example, the timing gap calculation part 14e acquires a plurality of voice packets A and extracts a sequence number identifying the order of packets from each voice packet A to calculate a time difference for each voice packet A by subtracting the acquisition time of the voice packet A having the previous sequence number and the frame time (20 milliseconds) from the acquisition time of each voice packet A.

If the sequence number is n apart, the time difference is calculated by subtracting n×20 milliseconds.

Then, the timing gap calculation part 14e forecasts and calculates the setting time set as the fluctuation absorption buffer length in the IP telephone that transmitted the voice packet A by calculating an absolute value of the time difference of each voice packet A and defining the maximum absolute value of the time difference as the setting time set as the fluctuation absorption buffer length.

The timing gap calculation part 14e also calculates the delay time specific to the IP telephone.

More specifically, the timing gap calculation part 14e acquires voice packets communicated between terminals exchanging voice packets to extract codec identification information for identifying the name of codec constituting the IP telephone from voice packets.

Then, the timing gap calculation part 14e calculates the delay time specific to the codec of the subordinate IP telephone by reading the delay time corresponding to the extracted codec identification information from the delay time storage part 13c.

Further, the timing gap calculation part 14e calculates the delay time specific to the IP telephone by adding the frame time (20 milliseconds) to the calculated codec specific delay time.

For example, if the timing gap calculation part 14e extracts codec identification information notifying that the IP telephone includes the G. 711 codec from a voice packet, the timing gap calculation part 14e calculates the delay time specific to the G. 711 codec, which is 10 milliseconds.

Then, the timing gap calculation part 14e calculates 30 milliseconds, which is the delay time specific to the IP telephone, by adding 20 milliseconds as the frame time to 10 milliseconds as the delay time specific to the G. 711 codec.

Then, the timing gap calculation part 14e calculates the timing gap by adding the delay time in the network, the setting time set as the fluctuation absorption buffer length, and the delay time specific to the IP telephone and stores the timing gap in the timing gap calculation part 14e.

If, for example, the timing gap calculation part 14e calculates that the delay time in the network is 5 milliseconds, the setting time set as the fluctuation absorption buffer length 20 milliseconds, and the delay time specific to the IP telephone 30 milliseconds, the timing gap calculation part 14e calculates 55 milliseconds as the timing gap and stores the timing gap in the timing gap calculation part 14e.

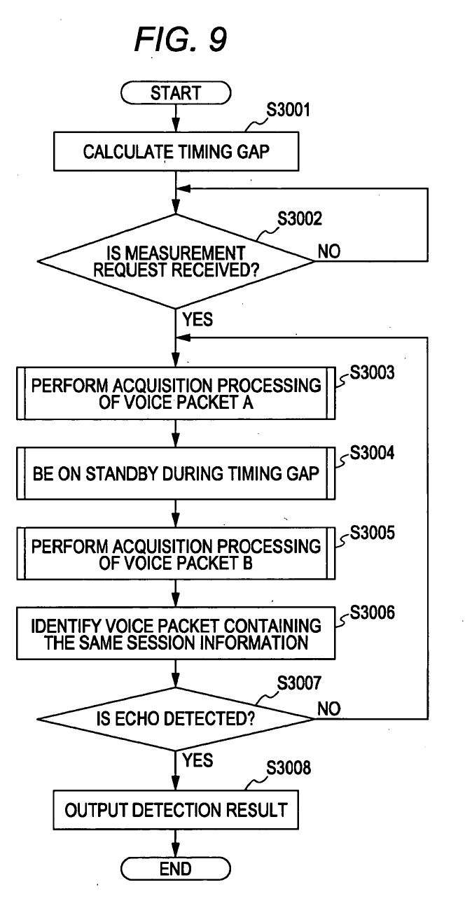

Next, processing by the measuring device 10 according to the third embodiment will be described using FIG. 9.

FIG. 9 illustrates a flow of processing by the measuring device according to the third embodiment.

Processing different from that by a measuring device according to the first embodiment will be described in detail below.

As shown in FIG. 9, the measuring device 10 calculates the timing gap in advance (operation S3001).

More specifically, the measuring device 10 calculates the timing gap by adding the delay time in a network, the setting time set as the fluctuation absorption buffer length, and the delay time specific to the IP telephone.

Then, after receiving a measurement request from a user (operation S3002: Yes), the measuring device 10 performs detection processing of voice packets containing an echo (operation S3003 to operation S3008 (corresponding to operation S1002 to operation S1007 shown in FIG. 4)) before terminating processing.

According to the third embodiment, as described above, the number of packets to be received and that of voice packets to be stored can be reduced by using the timing gap calculated in advance.

Incidentally, the timing gap as an update result by the timing gap change part 14d and that as a calculation result by the timing gap calculation part 14e may be stored for a long period of time so that the timing gap stored for a long time is reused when detection processing of voice packets containing an echo is performed again.

Thus, in the fourth embodiment, a case in which a timing gap stored for a long period of time is reused will be described.

In the fourth embodiment, a configuration of the measuring device 10 according to the fourth embodiment and a flow of processing by the measuring device 10 will be described. An effect obtained by the fourth embodiment will be described thereafter.

First, a configuration of the measuring device 10 according to the fourth embodiment will be described.

A configuration of the measuring device 10 according to the fourth embodiment is different from that of the measuring device 10 according to the second embodiment in a respect described below.

That is, the timing gap storage part 13b stores the standby time in association with inter-terminal identification information for inter-terminal identification.

More specifically, the timing gap storage part 13b stores the timing gap in association with a transmission/reception IP address (and a transmission/reception port number).

After receiving a notification of acquisition of the voice packet A from the packet A receiving part 14a, the packet B receiving part 14b extracts a transmission/reception IP address (and a transmission/reception port number) from the voice packet A and reads a timing gap stored in association with the transmission/reception IP address (and the transmission/reception port number) from the timing gap storage part 13b.

Here, if the timing gap is stored in the timing gap storage part 13b in association with the transmission/reception IP address (and the transmission/reception port number), the packet B receiving part 14b is on standby for the timing gap read from the timing gap storage part 13b and after the timing gap passes, starts to receive the packet B to acquire the voice packet B.

If, on the other hand, no timing gap is stored in the timing gap storage part 13b in association with the transmission/reception IP address (and the transmission/reception port number), the packet B receiving part 14b is on standby for the frame time (20 milliseconds) and after the frame time passes, starts to receive the packet B to acquire the voice packet B.

If the voice packet B containing an echo is detected, the echo detection part 15 stores the transmission/reception IP address (and the transmission/reception port number) contained in the voice packet A in association with the standby time stored in the timing gap storage part 13b.

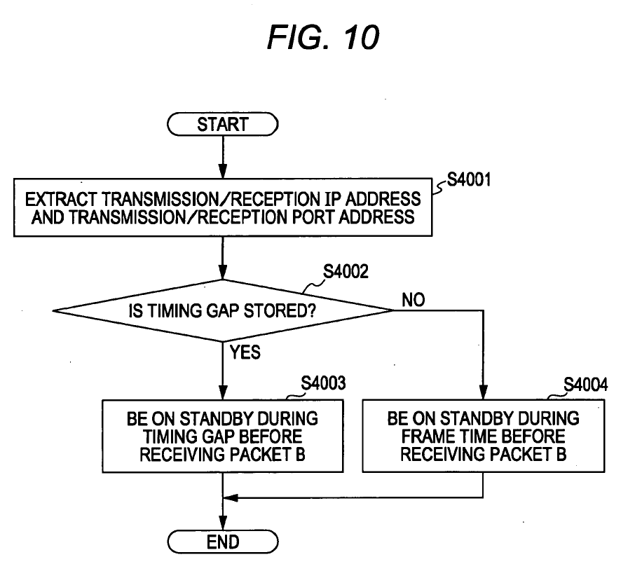

Next, processing by the measuring device 10 according to the fourth embodiment will be described using FIG. 10.

FIG. 10 illustrates a flow of standby processing by the measuring device according to the fourth embodiment.

In addition to further performing processing to store the transmission/reception IP address (and the transmission/reception port number) contained in the voice packet A in association with the standby time stored in the timing gap storage part 13b when the voice packet B containing an echo is detected, the measuring device according to the fourth embodiment is assumed to perform processing according to a flow of processing similar to that of a measuring device according to the first embodiment and standby processing (operation S1003 shown in FIG. 4) by the packet B receiving part 14b, which characterizes the measuring device according to the fourth embodiment, will be described in detail.

As shown in FIG. 10, after acquiring the voice packet A, the packet B receiving part 14b of the measuring device 10 extracts a transmission/reception IP address (and a transmission/reception port number) from the voice packet A (operation S4001) and reads a timing gap (operation S4002).

Here, if the timing gap is stored in association with the transmission/reception IP address (and the transmission/reception port number) of the voice packet A (operation S4002: Yes), the packet B receiving part 14b of the measuring device 10 is on standby for the timing gap before receiving the packet B (operation S4003).

If, on the other hand, no timing gap is stored in association with the transmission/reception IP address (and the transmission/reception port number) of the voice packet A (operation S4002: No), the packet B receiving part 14b of the measuring device 10 is on standby for the frame time before receiving the packet B (operation S4004).

According to the fourth embodiment, as described above, the number of packets to be received and that of voice packets to be stored can be reduced by reusing the standby time.

Incidentally, cases in which reception of packets continues until a fixed time (for example, 1 second) passes after starting reception of packets or until the number of voice packets stored in the packet storage part 13a reaches a predetermined number are described in the first to fourth embodiments, but packets may be received intermittently.

Thus, in the fifth embodiment, a case in which reception of packets continues intermittently will be described.

A case in which the packet A is intermittently received will be described in the fifth embodiment and after a configuration of the measuring device according to the fifth embodiment and a flow of processing by the measuring device is described, an effect by the fifth embodiment will be described.

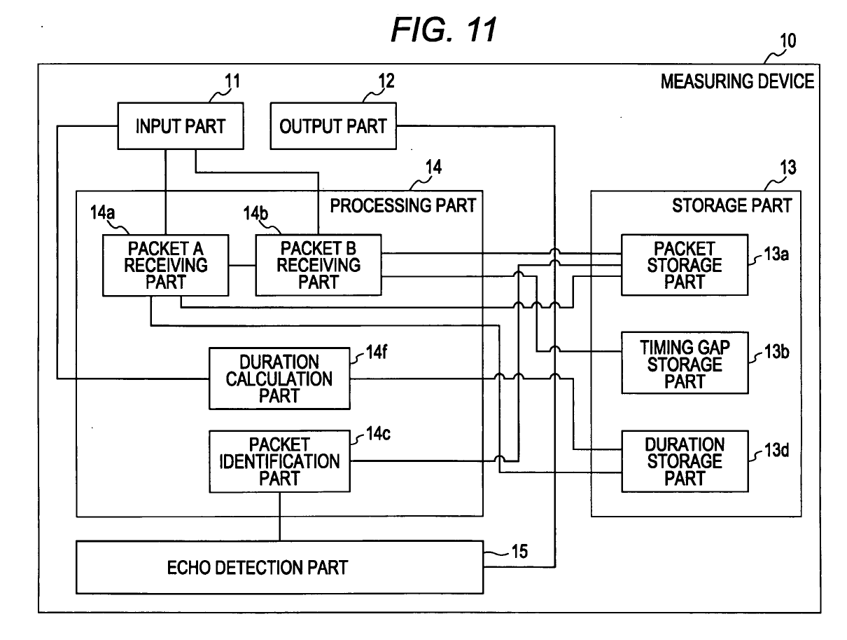

First, a configuration of the measuring device 10 according to the fifth embodiment will be described using FIG. 11.

FIG. 11 illustrates a configuration of a measuring device according to the fifth embodiment.

In addition to being newly provided with a duration storage part 13d and a duration calculation part 14f, a configuration of the measuring device 10 according to the fifth embodiment is different from that of the measuring device 10 according to the first embodiment in a respect described below.

That is, the duration storage part 13d stores the duration after starting reception of the packet A until reception of the packet A ends.

The duration calculation part 14f forecasts and calculates the duration in which packets are received, after examining a distribution of an acquisition delay time, which is a time different between a time when a voice packet should be acquired and a time when each voice packet is acquired, based on the distribution of the acquisition delay time.

According to an embodiment a duration calculation part 14f corresponds to a “duration calculator”.

Processing by the duration calculation part 14f will be described below by providing a concrete example and it is assumed that the duration calculation part 14f acquires the voice packet A communicated between predetermined terminals in each frame time (20 milliseconds).

The duration calculation part 14f acquires each voice packet A flowing in the X direction between the predetermined terminals and after acquiring the first voice packet A, for example, acquires the voice packet A “after 20 milliseconds”, “after 45 milliseconds”, “after 62 milliseconds”, and “after 78 milliseconds”.

Here, the duration calculation part 14f calculates a time difference for each acquired voice packet A by subtracting a time when the voice packet A should be acquired from a time when the voice packet A is acquired.

For example, because the voice packet A acquired “after 45 milliseconds” should actually be acquired “after 40 milliseconds” and thus, the duration calculation part 14f calculates 5 milliseconds as a time difference for the voice packet A acquired “after 45 milliseconds”.

Subsequently, the duration calculation part 14f specifies the acquisition time of the voice packet A, among time differences calculated for each acquired voice packet A, with the smallest time difference as the reference time (that is, “after 78 milliseconds” with the time difference of −2 seconds).

Subsequently, the duration calculation part 14f converts each time difference calculated for each acquired voice packet A into one based on the reference time.

For example, the duration calculation part 14f calculates a converted time difference of 7 milliseconds by adding 2 milliseconds to the time difference of 5 milliseconds of the voice packet A acquired “after 45 milliseconds” (that is, if “after 78 milliseconds” is defined as the reference time when the voice packet A should be acquired, this means that the voice packet A acquired “after 45 milliseconds” is acquired 7 milliseconds after the time when the voice packet A should be acquired).

Subsequently, the duration calculation part 14f calculates the duration by examining the distribution of each converted time difference.

For example, the duration calculation part 14f calculates the largest time difference among converted time differences as the duration (that is, all voice packets A are acquired within 7 milliseconds from the time when the voice packet A should be acquired based on the reference time).

Then, the duration calculation part 14f stores the calculated duration in the duration storage part 13d.

The packet A receiving part 14a starts to receive a packet at each time when a voice packet should be received and continues reception of packets in the duration calculated by the duration calculation part 14f.

More specifically, the packet A receiving part 14a starts to receive a packet at each time “20×n (“n” represents a variable)” milliseconds pass from the time specified by the duration calculation part 14f as the reference time.

Subsequently, the packet A receiving part 14a reads the duration from the duration storage part 13d and continues reception of the packet A in the duration.

Then, the packet A receiving part 14a temporarily stops reception of the packet A after the duration passes.

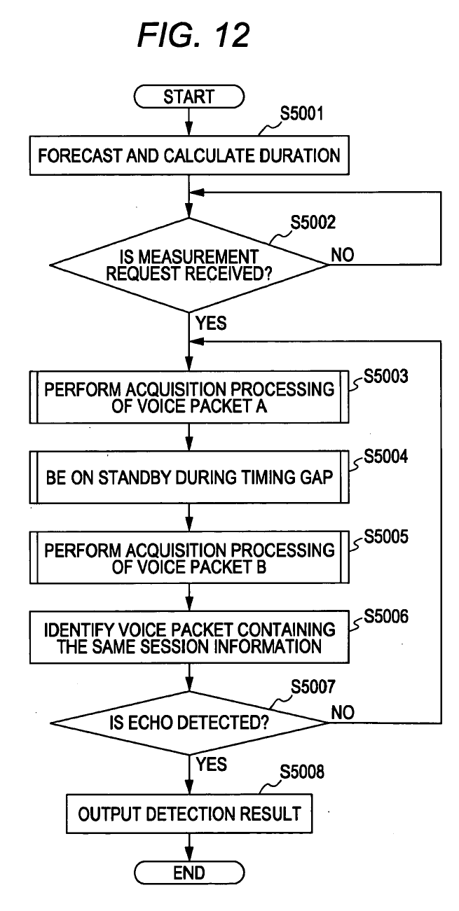

Next, processing by the measuring device 10 according to the fifth embodiment will be described using FIG. 12.

FIG. 12 illustrates a flow of processing by the measuring device according to the fifth embodiment.

Processing different from that by a measuring device according to the first embodiment will be described in detail below.

As shown in FIG. 12, the measuring device 10 forecasts and calculates the duration in which packets are received (operation S5001).

Then, after receiving a measurement request from a user (operation S5002: Yes), the measuring device 10 performs detection processing of voice packets containing an echo (operation S5003 to operation S5008 (corresponding to operation S1002 to operation S1007 shown in FIG. 4)) before terminating processing.

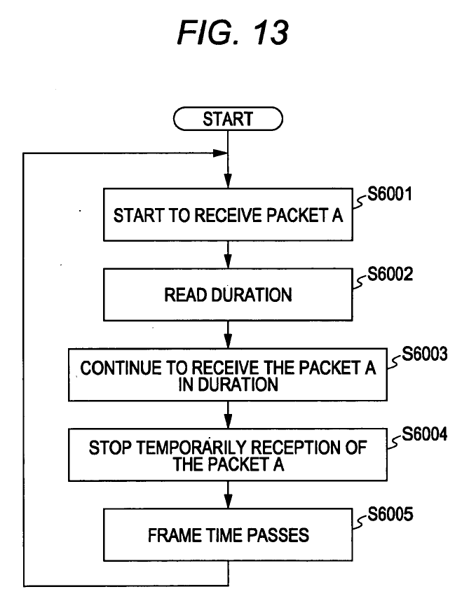

Next, packet A receiving processing (corresponding to operation S1002 shown in FIG. 4) by the packet A receiving part 14a, which characterizes the measuring device according to the fifth embodiment, will be described in detail using FIG. 13.

FIG. 13 illustrates a flow of packet A receiving processing by the measuring device according to the fifth embodiment.

The packet A receiving part 14a terminates reception of the packet A after a fixed time (for example, 1 second) passes or the number of the voice packets A stored in the packet storage part 13a reaches a predetermined number.

As shown in FIG. 13, after receiving a measurement request from a user, the packet A receiving part 14a of the measuring device 10 starts to receive the packet A from the time when the voice packet should be acquired (operation S6001).

Subsequently, the packet A receiving part 14a of the measuring device 10 reads the duration from the duration storage part 13d (operation S6002) and continues reception of the packet A in the duration (operation S6003).

Then, after the duration passes, the packet A receiving part 14a of the measuring device 10 temporarily stops reception of the packet A (operation S6004) and when the frame time (20 milliseconds) passes after starting to receive packets last time (operation S6005), restarts reception of the packet A (operation S6001).

According to the fifth embodiment, as described above, the number of packets to be received and that of voice packets to be stored can be reduced by intermittently receiving packets.

The first to fifth embodiments have been described above, but the present invention is not limited to the above embodiments and may be embodied in various ways.

Thus, other embodiments will be described below as the sixth embodiment.

In the first to fifth embodiments, for example, a case in which reception of the packet B is started when the timing gap passes after acquiring the voice packet A is described. However, the present invention is not limited to this and reception of the packet A may be started when the timing gap passes after acquiring the voice packet B.

Also in the first to fifth embodiments, it is assumed that up and down packets pass through the same cable, but if up and down packets pass through different routes, up and down packets may be input into the measuring device from each route.

Also in the first to fifth embodiments, the IP address (and the transmission/reception port number) is used for identification of up and down sessions, but analysis of signaling protocols such as SIP and H. 323 or information provided from an IP telephone server may also be used for identification.

Also in the third embodiment, the maximum value of absolute values of time differences of each voice packet A is used as the fluctuation absorption buffer length, but the maximum value may be determined by emulating a fluctuation absorption buffer at a terminal or from a distribution of fluctuations.

Also in the third embodiment, a case in which the delay time in a network is calculated by using RR packets of RTCP packets and SR packets of RTCP packets is described. However, the present invention is not limited to this, and the delay time may be calculated, for example, by transmitting a ping packet of ICMP (Internet control message protocol) to the IP telephone to acquire information needed for calculating the delay time in a network.

Also in the third embodiment, a case in which the standby time as a timing gap is calculated by adding the delay time in a network, the setting time set as a fluctuation absorption buffer length, and the delay time specific to the codec constituting the IP telephone is described, but the present invention is not limited to this. If one or a plurality of calculation results is defined as the standby time as a timing gap, for example, the delay time in a network defined as the standby time as a timing gap or the standby time as a timing gap defined by adding the delay time in a network and the setting time set as a fluctuation absorption buffer length in the IP telephone, such standby times can be applied to the present invention.

Also in the fifth embodiment, a case in which the packet A is intermittently received is described. However, the present invention is not limited to this and a case in which the packet A and/or the packet B is intermittently received can be applied to the present invention.

The network configuration described in the first embodiment does not limit the present invention, and a case in which each packet flowing in both directions in a network is received can be applied to the present invention.

For example, even a case in which a flow of voice packets related to the IP telephone is controlled by a call control server and each voice packet is received from a network in which only voice packets related to the IP telephone flow can also be applied to the present invention.

Processing procedures, control procedures, concrete names, and information containing various kinds of data and parameters (for example, storage information shown in FIG. 8 and the numeric range calculated as a duration) shown above and drawings may optionally be changed if not specifically mentioned.

That is, the numeric range calculated as the duration may be defined, for example, as a time difference (such as 6 milliseconds) covering 90% in a distribution of converted time differences.

Each component of each illustrated device need not necessarily be configured physically as illustrated.

That is, distribution/integration of each device are not limited by those illustrated and the whole or part thereof may be functionally or physically distributed/integrated in any units in accordance with various kinds of load or using conditions.

For example, the packet A receiving part 14a and the packet B receiving part 14b shown in FIG. 3 may be configured by integrating both.

Further, the whole or any part of each processing function performed by each device is realized by a CPU and a program analyzed and executed by the CPU, or by hardware based on wired logic.

An exemplary embodiment of the present invention may be realized by executing prepared programs on a computer as the measuring device 10.

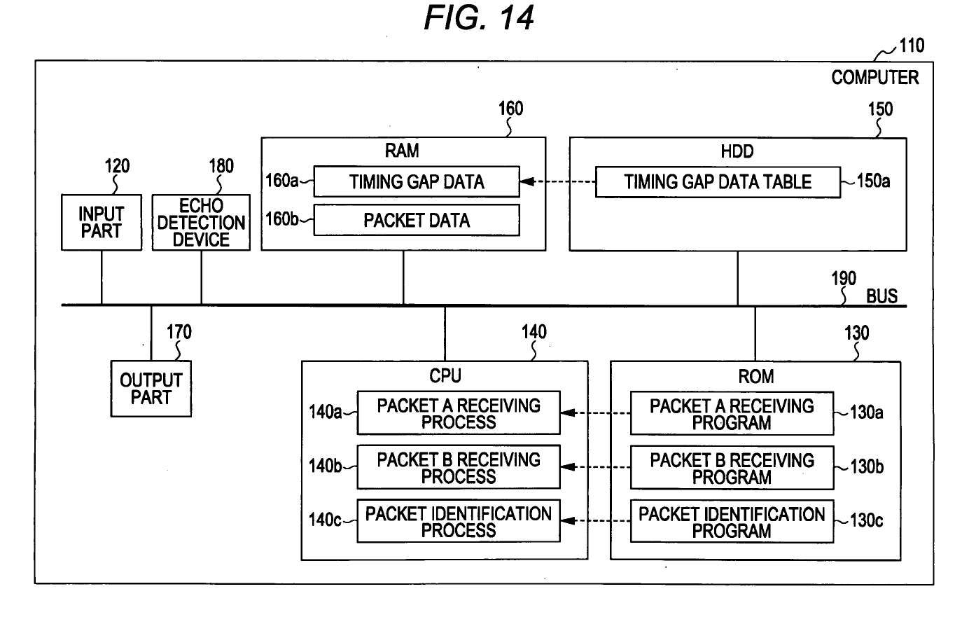

Thus, a computer executing measuring programs having the same function as that of the measuring device 10 is described as an example using FIG. 14.

FIG. 14 is a diagram showing a computer executing packet capturing programs.

As shown in FIG. 14, a computer 110 as the measuring device 10 is configured by connecting an input part 120, a ROM 130, a CPU 140, an HDD 150, a RAM 160, an output part 170, and an echo detection part 180 using a bus 190.

In the ROM 130, packet capturing programs causing the computer 110 to exhibit the same function as that of the measuring device 10 shown in the above first embodiment are stored.

That is, as shown in FIG. 14, a packet A receiving program 130a, a packet B receiving program 130b, and a packet identification program 130c are stored in the ROM 130 in advance.

These programs 130a to 130c may be, like each component of the measuring device 10 shown in FIG. 3, integrated or distributed according to circumstances.

Then, when the CPU 140 reads these programs 130a to 130c from the ROM 130 to execute these programs, as shown in FIG. 14, the program 130a, the program 130b, and the program 130c will function as a packet A receiving process 140a, a packet B receiving process 140b, and a packet identification process 140c, respectively.

The packet A receiving process 140a, the packet B receiving process 140b, and the packet identification process 140c correspond to the packet A receiving part 14a, the packet B receiving part 14b, and the packet identification part 14c, respectively.

As shown in FIG. 14, the HDD 150 is provided with a timing gap data table 150a.

Then, the CPU 140 reads timing gap data 160a from the timing gap data table 150a to store the timing gap data 160a in the RAM 160 and performs processing based on packet data 160b received via the input part 120.

The timing gap data 160a corresponds to the timing gap storage part 13b shown in FIG. 3 and the packet data 160b corresponds to the packet storage part 13a shown in FIG. 3.

Incidentally, each of the programs 130a to 130c need not necessarily be stored in the ROM 130.

For example, each program may be stored in a “portable physical medium” such as a flexible disk (FD) inserted into the computer 110, CD-ROM, DVD disk, magneto-optical disk, and IC card, a “fixed physical medium” such as an HDD provided inside or outside the computer 110, and further in “another computer (or a server)” connected to the computer 110 via a public network, the Internet, LAN, and WAN so that the computer 110 reads each program from these media for execution.

The packet capturing method described in the present embodiment can be realized by executing prepared packet capturing programs on a computer such as a personal computer or a workstation.

Such packet capturing programs can be distributed via a network such as the Internet.

These packet capturing programs can also be executed by being recorded in a computer readable recording medium such as a hard disk, flexible disk (FD), CD-ROM, MO, and DVD and read by a computer.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A packet capturing apparatus comprising:
a first acquisition part acquiring a voice packet having voice information, after receiving each packet transferred in a network, from the received packets;
a measuring part measuring an elapsed time after receiving the acquired voice packet;
a second acquisition part starting to receive a voice packet transferred in a direction opposite to a transfer direction of the acquired voice packet when the elapsed time reaches a predetermined standby time; and
an output part outputting the voice packet acquired by the first acquisition part and the voice packet acquired by the second acquisition part corresponding to the acquired voice packet to an echo detection device detecting an echo generated when the voice information is decoded based on each of the voice packets.

2. The packet capturing apparatus according to claim 1, comprising:
a standby time update part updating the predetermined standby time processed by the second acquisition part, when an echo is not detected by the echo detection device, based on a reproduction time of the voice information from which the echo detected.

3. The packet capturing apparatus according to claim 1, comprising:
a standby time calculation part calculating the standby time using control information used for transmission/reception control of packets to update the predetermined standby time processed by the second acquisition part using the calculated standby time.

4. The packet capturing apparatus according to claim 1, wherein
the second acquisition part controls the predetermined standby time for each piece of inter-terminal identification information identifying a transmitting terminal and a receiving terminal of the voice packet acquired by the first acquisition part.

5. The packet capturing apparatus according to claim 1, comprising:
a duration calculation part forecasting and calculating a duration in which packets are received, after examining a distribution of an acquisition delay time, which is a time different between a time when each voice packet should be acquired and a time when each voice packet is actually acquired, based on the distribution of the acquisition delay time, wherein
the second acquisition part starts to receive packets at each time when a voice packet should be acquired and continues to receive packets in the duration calculated by the duration calculation part.

6. A method used by a packet capturing apparatus comprising:
a first acquisition operation of acquiring a voice packet having voice information, after receiving each packet transferred in a network, from the received packets;
a measuring operation of measuring an elapsed time after receiving the acquired voice packet;
a second acquisition operation of starting to receive a voice packet transferred in a direction opposite to a transfer direction of the acquired voice packet when the elapsed time reaches a predetermined standby time; and
an output operation of outputting the voice packet acquired in the first acquisition operation and the voice packet acquired in the second acquisition operation corresponding to the acquired voice packet to an echo detection device detecting an echo generated when the voice information is decoded based on each of the voice packets.

7. A computer readable recording medium in which a program causing the computer to execute as a packet capturing apparatus, the program comprising:
a first acquisition operation of acquiring a voice packet having voice information, after receiving each packet transferred in a network, from the received packets;
a measuring operation of measuring an elapsed time after receiving the acquired voice packet;
a second acquisition operation of starting to receive a voice packet transferred in a direction opposite to a transfer direction of the acquired voice packet when the elapsed time reaches a predetermined standby time; and
an output operation of outputting the voice packet acquired in the first acquisition operation and the voice packet acquired in the second acquisition operation corresponding to the acquired voice packet to an echo detection device detecting an echo generated when the voice information is decoded based on each of the voice packets.
